(19) United States
(12) Patent Application Publication
(10) Pub. No.: US 2008/0310846 A1
(43) Pub. Date: Dec. 18, 2008

(54) FREQUENCY MODULATED BURST MODE TRANSMITTER

(76) Inventors: Lamar E. West, JR., Maysville, GA (US); Pieter G. Ibelings, Norcross, GA (US)

Correspondence Address: Scientific-Atlanta, Inc.;Intellectual Property Dept., MS 4.3.518, 5030 Sugarloaf Parkway, Lawrenceville, GA, 30044, US

(21) Appl. No.: 11/762,291

(22) Filed: Jun. 13, 2007

(51) Int. Cl. H04B 10/00

(52) U.S. Cl. 398/115

(57) ABSTRACT

The present invention is directed towards a frequency modulated burst mode optical transmitter and systems and methods related thereto. Reverse electrical signals are used to frequency modulate a carrier signal. A carrier detect circuit checks for the presence of a subcarrier signal in received reverse electrical signals. When a subcarrier signal is detected, a laser is turned on and the frequency modulated carrier signal is used to intensity modulate the laser to provide an optical signal. In the absence of a subcarrier signal, the laser is turned off and no optical signals are transmitted. By operating in a burst mode, resources are conserved as optical signals are transmitted only when content-carrying reverse electrical signals are received. A delay circuit may be included to prevent loss of any signal information

### TECHNICAL FIELD

The present invention is generally related to a communications system and, more particularly, is related to systems and methods for transmitting reverse optical signals by a frequency modulated burst mode transmitter.

### BACKGROUND OF THE INVENTION

Hybrid fiber/coaxial (HFC) communications systems transmit signals in a forward and reverse path between a headend and a plurality of subscribers. In the reverse path, a coaxial cable feeder portion connects the subscriber equipment (e.g., cable modems, digital set-top boxes) with an optical node, which conventionally converts the radio frequency (RF) signals received from the subscriber equipment to optical signals, that sits at the input of an optical link. Subsequently, the optical link connects the reverse path from the optical node to a hub or headend where they are processed accordingly.

Lasers used for reverse path signaling in the conventional approach to HFC network design are intensity modulated by the RF electrical signals that contain information for transmission in the reverse path. Ideally the light intensity from these lasers is proportional to the electrical signals. The light is launched down a reverse path optical fiber and is attenuated by an amount that is a function of the length of that fiber. RF output power levels from conventional optical receivers are a function of the received optical input power. Variations in the length of optical fibers throughout the HFC network result in variations in the received optical power at the input of each optical receiver. Consequently, RF output power is manually adjusted at each optical receiver to compensate for variations in optical loss from link to link. Therefore, there is a need to address the deficiencies and/or inadequacies of reverse optical transmitters.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an abridged block diagram of a communications system that is suitable for use in implementing the present invention.

FIG. 2 illustrates one link in the reverse direction of the broadband communications system of FIG. 1.

FIG. 3 is a block diagram of a first embodiment of a frequency modulated burst mode optical transmitter in accordance with the present invention.

FIG. 4 is a block diagram of a frequency modulated optical receiver that is suitable for use with the frequency modulated burst mode transmitter of FIG. 3.

FIG. 5 is a block diagram of a second embodiment of a frequency modulated burst mode optical transmitter in accordance with the present invention.

### DETAILED DESCRIPTION OF THE PREFERRED EMBODIMENTS

The preferred embodiments of the invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. Furthermore, all “examples” given herein are intended to be non-limiting.

The present invention is directed towards a frequency modulated (FM) burst mode optical transmitter that uses received reverse electrical signals to frequency modulate an RF carrier signal which is in turn used to modulate a laser. It is noted that information-carrying reverse electrical signals are transmitted on predetermined carrier frequencies. For teaching purposes, to distinguish the carrier signals of the reverse electrical signals from the RF carrier signal that is frequency modulated, the reverse electrical signal carrier frequencies are referred to herein as subcarrier frequencies, and are generally in the MHz range. For example, reverse electrical signals are typically received at frequencies within the bands of 5 MHz to 45 MHz, 5 MHz to 108 MHz, 5 MHz to 174 MHz, or 5 MHz to 88 MHz, depending upon the application. The signal that is frequency modulated by the FM burst mode optical transmitter of the invention is referred to as the RF carrier signal and, in an exemplary embodiment, is in the GHz range, for example 1.21 GHz. The frequency modulated RF carrier signal is then used to intensity modulate a laser. In this manner, since the optical signal transports the desired information in the frequency domain as opposed to the signal amplitude, longer fiber distances can be used with significant signal attenuation since FM signals are more robust than amplitude modulated signals. The FM burst mode optical transmitter of the present invention includes a carrier detect circuit, which initially detects the presence of a subcarrier signal present in the reverse electrical signals. Conventional optical transmitters typically bias the laser so that the laser continuously generates a reverse optical signal regardless of the presence of a reverse electrical subcarrier signal. By using the carrier detect circuit of the present invention, the laser can be turned on when a reverse electrical signal on a subcarrier frequency is detected, and turned off otherwise. Accordingly, only when a subcarrier signal is detected does the FM burst mode optical transmitter send an optical signal to an optical receiver located further upstream.

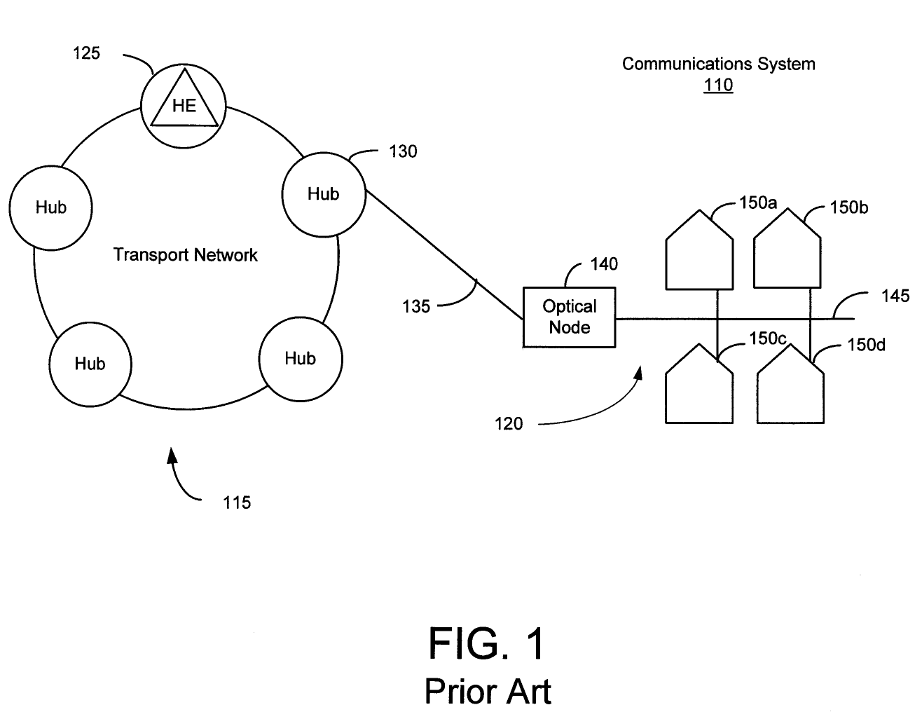

FIG. 1 is an abridged block diagram of a communications system 110 that is suitable for use in implementing the present invention. Typically, the communications system 110 includes a transport network 115 and a transmission network 120. The transport network 115, which is fiber optic cable, connects a headend 125 and hubs 130 for generating, preparing, and routing programs and other optical packets over longer distances; whereas the transmission network 120, which is coaxial cable, generally routes electrical packets over shorter distances. Programs and other information packets received, generated, and/or processed by headend equipment can be broadcast to all subscribers in the system 110, or alternatively, can be selectively delivered to one or more subscribers. Fiber optic cable 135 connects the transport network 115 to an optical node(s) 140 which converts the packets from optical packets to electrical packets. Thereafter, coaxial cable 145 routes the electrical packets to one or more subscriber premises 150a-d.

In the reverse, or upstream, direction, subscriber premises equipment, such as set-top boxes or cable modems, generate reverse electrical signals. The optical node 140, which includes an optical transmitter, converts the reverse electrical signals into optical signals for further routing to the hubs 130. The hubs 130 then route the optical signals to the headend 125 for further processing.

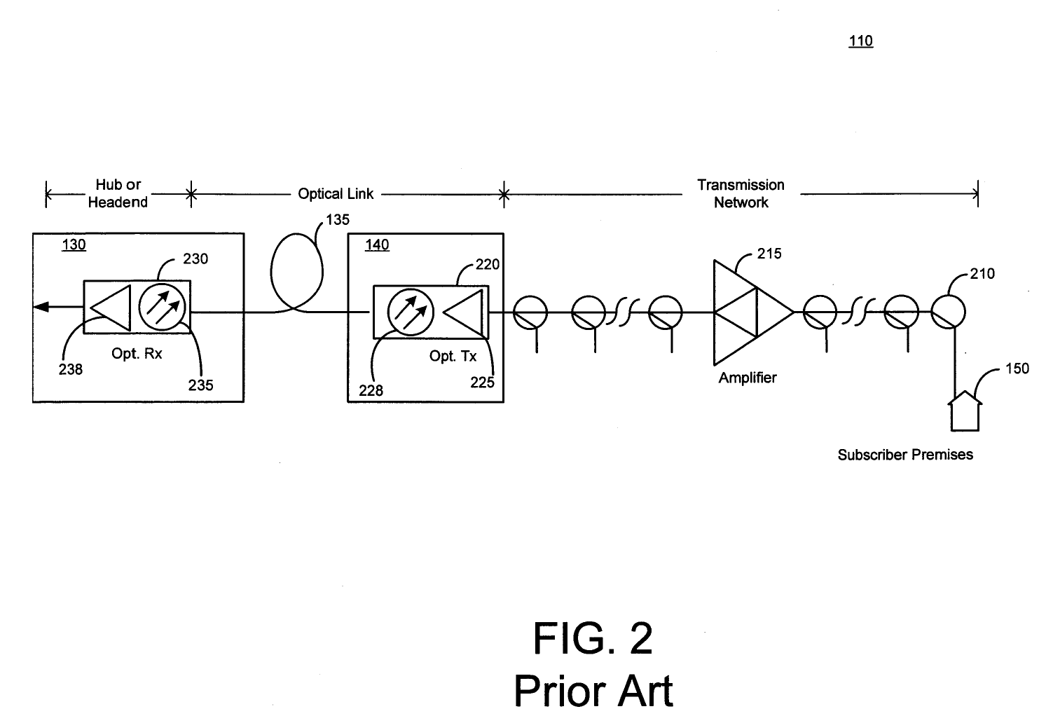

FIG. 2 illustrates one link in the reverse direction of the broadband communications system 110 of FIG. 1. A tap 210 receives the reverse electrical signals from a subscriber 150 and combines the signals with other reverse electrical signals being transmitted on that path. An amplifier 215 amplifies the combined electrical signals as necessary. At the demarcation point between the transmission network and the optical links is the optical node 140 which includes an optical transmitter 220. Reverse electronics 225, such as amplifiers and other configuration modules, prepare the signals for conversion into optical signals by laser 228. The optical signals are then transported across optical fiber 135 to an optical receiver 230, which is included in either the headend 125 or the hub 130. The optical receiver 230 converts the optical signals back into electrical signals via a photodiode 235 and reverse electronics 238 further condition the signal as required. The reverse electrical signals, which have been combined from various subscribers 150a-d, are then provided to headend equipment. As mentioned, however, the optical signals are susceptible to signal attenuation in the case of analog optical signal transport, or require expensive digital electronics in order to convert the optical signals into a digital optical signal. The present invention, in contrast, transports frequency modulated optical signals where the information of the reverse signals is carried in the frequency domain, rather than the signal amplitude, so that long fiber can be used without incurring significant signal losses.

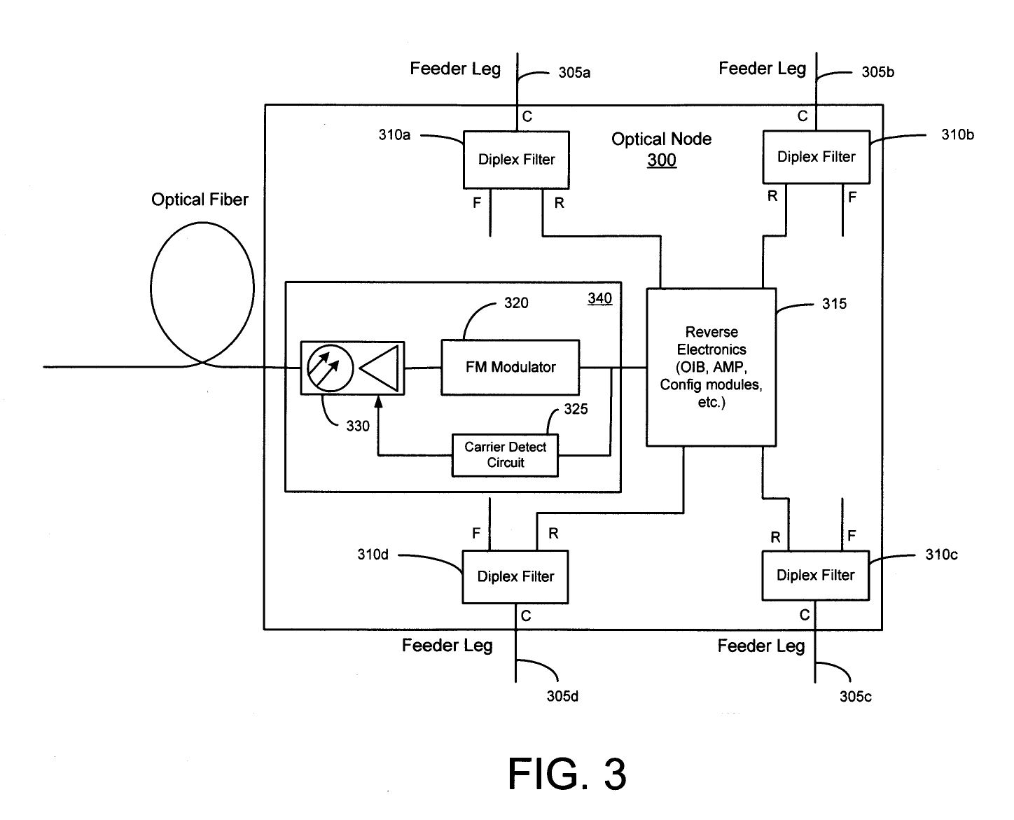

FIG. 3 is a block diagram of a first embodiment of an optical node 300 that includes an exemplary embodiment of an FM burst mode optical transmitter 340 of the present invention. Feeder legs 305a-d receive reverse electrical signals from subscribers located on four different paths. Any number of feeder legs can be input to the optical node 300. Diplex filters 310a-d isolate the reverse electrical signals from the forward, or downstream, signals. Reverse electronics 315 then amplify, combine, and configure the signals in a known manner. The output of reverse electronics 315 is then input to the FM burst mode optical transmitter 340.

In the exemplary embodiment shown in FIG. 3, the FM burst mode optical transmitter 340 includes an FM modulator 320, a carrier detect circuit 325, and a laser 330. As shown in FIG. 3, the output of the reverse electronics 315 is input to the FM modulator 320 and the carrier detect circuit 325 of the FM burst mode optical transmitter 340. The FM modulator 320 uses the reverse electrical signals to modulate an RF carrier signal. In an exemplary embodiment, a 1.21 GHz carrier signal is frequency modulated with the reverse electrical signals. The carrier detect circuit 325 detects the presence of a subcarrier signal in the reverse electrical signals. Typically, electrical noise, interference and other undesired ingress signals are received at the feeder legs 305 a-d; thus some sort of reverse electrical signals are present at the optical node 300 regardless of the presence of a subcarrier signal with desired information. The carrier detect circuit 325 can detect the presence of a subcarrier signal in the reverse electrical signals and control the laser 330 accordingly. More specifically, when a subcarrier signal is detected, the carrier detect circuit 325 turns the laser 330 on so that it can be intensity modulated with the frequency modulated 1.21 GHz RF carrier signal. When a carrier signal is not detected, the laser 330 is turned off so that no optical signals are transmitted upstream. In a further exemplary embodiment, the carrier detect circuit 325 can control the FM modulator 320 so that the carrier signal (for example, a 1.21 GHz signal) is frequency modulated with the reverse electrical signals only when a subcarrier signal is detected. In yet a further embodiment, the carrier detect circuit 325 can control the means used to perform the modulation of the laser, for example the carrier detect circuit 325 may control an optical modulation modulator. Additional information regarding the transmission of frequency modulated optical signals can be found in copending U.S. patent application Ser. No. 11/683,640 entitled “Reverse Path Optical Link using Frequency Modulation”, filed on Mar. 8, 2007, and U.S. Pat. No. 6,509,994 entitled “Burst Mode Analog Transmitter”, filed on Apr. 23, 2001, the disclosures and teachings of which are hereby incorporated by reference.

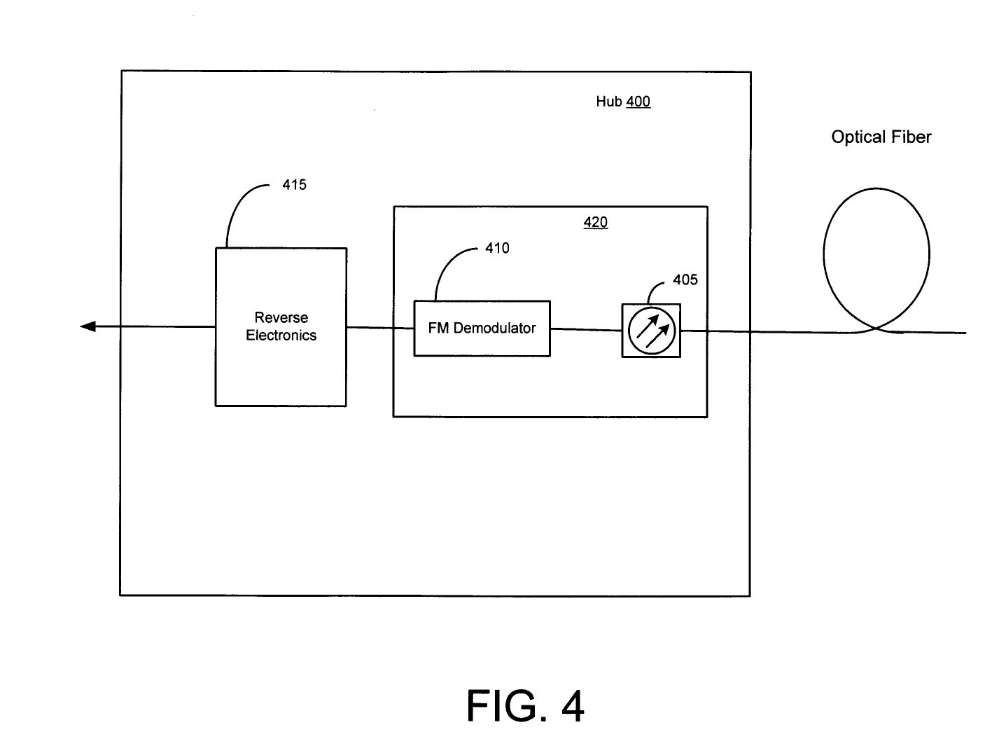

FIG. 4 is a block diagram of a hub 400 that includes an exemplary embodiment of a reverse FM optical receiver 420 that is suitable for use with the FM burst mode transmitter 340 of FIG. 3. The reverse FM optical receiver 420, which is coupled to the FM burst mode transmitter 340, receives the optical signal that is present only when reverse signals in the subcarrier frequency band(s) are present at the input to the carrier detect circuit 325 in the burst mode optical transmitter 340. A photodiode 405 converts the optical signals back into electrical signals. Subsequently, an FM demodulator 410 demodulates the electrical signals. Reverse electronics 415 further condition the signal prior to further transmission to headend equipment.

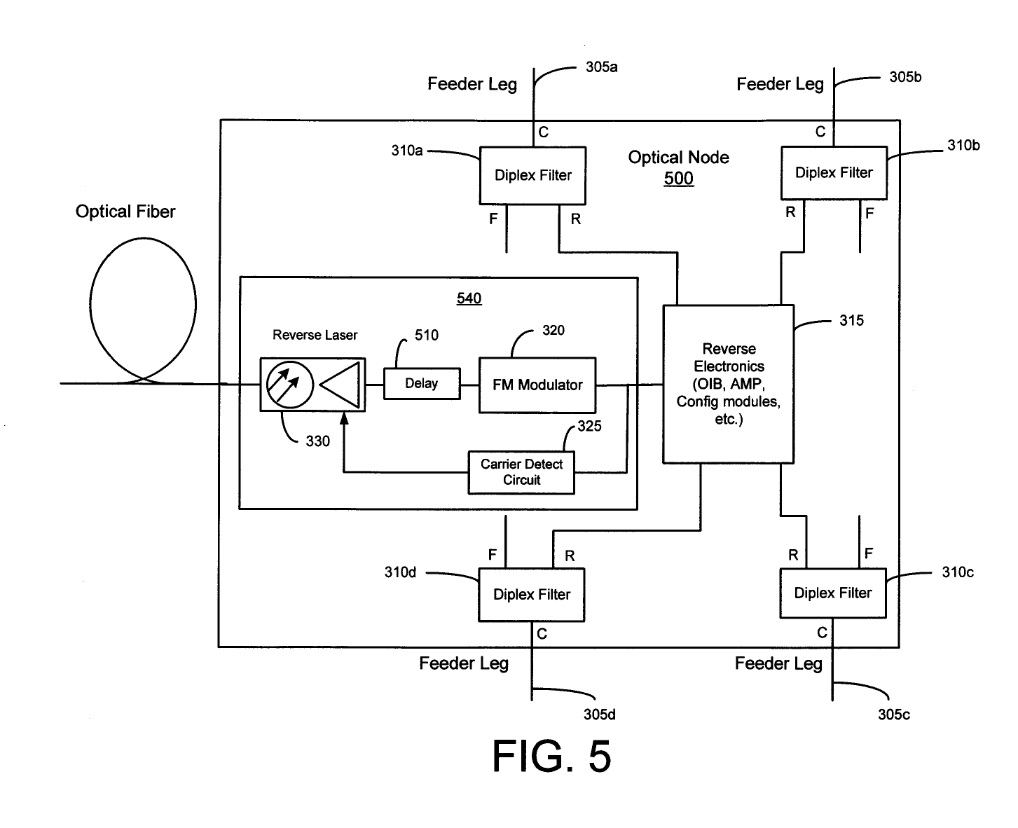

FIG. 5 is a block diagram of an optical node 500 that includes an FM burst mode optical transmitter 540 in accordance with a further embodiment of the present invention. The FM burst mode optical transmitter 540 includes a delay circuit 510. The delay circuit 510 delays the frequency modulated electrical signals by an appropriate time in order to allow the carrier detect circuit 325 to detect the presence of a subcarrier signal and then turn on the laser 330. In this manner, reverse signals are not lost due to any time delays by the carrier detect circuit 325.

Accordingly, systems and methods have been described that enable a frequency modulated burst mode optical transmitter. It should be emphasized that the above-described embodiments of the present invention, particularly, any “preferred” embodiments, are merely possible examples of implementation set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and protected by the following claims.

1. A method for transmitting burst mode optical signals, the method comprising:
receiving reverse electrical signals;
checking for the presence of a subcarrier signal within the reverse electrical signals via a carrier detecting means;
frequency modulating a carrier signal with the reverse electrical signals; and
intensity modulating a laser with the frequency modulated carrier signal to produce an optical signal when the subcarrier signal is detected.

2. The method of claim 1, wherein the reverse electrical signals are received at a predetermined subcarrier frequency.

3. The method of claim 1, wherein the frequency modulated carrier signal is a predetermined GHz signal.

4. The method of claim 1, further comprising preventing transmission of an optical signal when no subcarrier signal is detected.

5. The method of claim 1, further comprising controlling the optical modulation means via the carrier signal detecting means.

6. The method of claim 1, further comprising preventing the frequency modulation of a carrier signal when no subcarrier signal is detected.

7. The method of claim 1, further comprising controlling the frequency modulation means via the carrier signal detecting means.

8. The method of claim 1, further comprising delaying the frequency modulated carrier signal.

9. A method for transmitting and receiving burst mode optical signals, the method comprising:
at an optical transmitter,
receiving electrical signals;
checking for the presence of a subcarrier signal within the received electrical signals via a carrier detect circuit;
frequency modulating a carrier signal with the received electrical signals;
intensity modulating a laser with the frequency modulated carrier signal to provide an optical signal when the subcarrier signal is present; and
transmitting the optical signal along optical fiber;
at an optical receiver,
converting the optical signal into a frequency modulated electrical signal; and
demodulating the frequency modulated electrical signal.

10. The method of claim 9, further comprising, preventing transmission of an optical signal when no subcarrier signal is detected by the carrier detect circuit.

11. The method of claim 9, further comprising controlling an optical intensity modulation modulator via the carrier detect circuit.

12. The method of claim 9, further comprising preventing the frequency modulation of a carrier signal when no subcarrier signal is detected.

13. The method of claim 12, wherein the carrier detect circuit controls a frequency modulation modulator.

14. The method of claim 9, further comprising delaying the frequency modulated carrier signal by a predetermined time.

15. A system for transmitting and receiving burst mode optical signals, the system comprising:
an optical transmitter adapted to receive electrical signals and to convert the electrical signals into optical signals by using the electrical signals to frequency modulate a carrier signal, said frequency modulated carrier signal in turn used to intensity modulate a laser to provide an optical signal only when a subcarrier signal is present in the electrical signals; and
an optical receiver to receive the optical signals and convert the optical signals into frequency modulated electrical signals.

16. The system of claim 16, the optical transmitter comprising:
a carrier detect circuit to detect the presence of a subcarrier signal;
a frequency modulation modulator to frequency modulate the carrier signal; and
a laser to provide the optical signals.

17. The system of claim 16, wherein the carrier detect circuit controls the laser so that the laser is turned on when a subcarrier signal is detected and the laser is turned off when a subcarrier signal is absent.

18. The system of claim 16, wherein the carrier detect circuit controls an input of the frequency modulation modulator, wherein, in the presence of a subcarrier signal, the frequency modulation modulator receives the electrical signals at the input, and wherein, in the absence of a subcarrier signal, the electrical signals are dropped prior to the input of the frequency modulation modulator.

19. The system of claim 17, further comprising a delay circuit positioned between the frequency modulation modulator and the laser, the delay circuit for delaying the frequency modulated carrier signal by a predetermined time.

20. A burst mode optical transmitter, comprising:
a carrier detect circuit to check for the presence of a subcarrier signal within reverse electrical signals;
a frequency modulation modulator to modulate a carrier signal using the reverse electrical signals; and
a laser to provide an optical signal that is intensity modulated by the frequency modulated carrier signal when a subcarrier signal is detected.

21. The burst mode transmitter of claim 20, further comprising a delay circuit to delay the frequency modulated carrier signal by a predetermined amount of time.

22. The burst mode transmitter of claim 20, wherein no optical signal is transmitted when a subcarrier signal is absent.

23. The burst mode transmitter of claim 20, wherein the carrier signal is not modulated when the subcarrier signal is absent.
